(19) United States
(12) Patent Application Publication
(10) Pub. No.: US 2008/0292067 A1
(43) Pub. Date: Nov. 27, 2008

(54) Terminal Equipment and Method Thereof

(76) Inventor: Seung Hwan Lee, Sung (KR)

Correspondence Address: BIRCH STEWART KOLASCH & BIRCH, PO BOX 747, FALLS CHURCH, VA, 22040-0747, US

(21) Appl. No.: 12/158,301

(22) PCT Filed: Dec. 7, 2006
(86) PCT No.: PCT/KR2006/005293

§ 371 Date: Jun. 19, 2008

(30) Foreign Application Priority Data
Dec. 21, 2005 (KR) 10-2005-0126933

(51) Int. Cl. H04M 11/00

(52) U.S. Cl. 379/52

(57) ABSTRACT

The present invention relates to a terminal for hard of-hearing and speech-disabled people and a character transmitting and receiving method using the same, in a mobile communication system that provides voice communication services using a mobile terminal, such as CDMA, and a system that provides voice communication services through a packet communication network, such as VoIP. A character communication function is implemented in a mobile terminal or a VoIP phone that is widely spread. The character communication function matches to a function that transfers character information for hard of-bearing and speech-disabled people along a path that provides voice services, and thus a user can freely communicate simply using the mobile terminal or VoIP phone. It is advantageous in that character communications can be performed without modifying the systems or hardware of the terminal, and communication mobility is provided to hard of-hearing and speech-disabled people.

### TECHNICAL FIELD

The present invention relates to a terminal for hard of-hearing and speech-disabled people and a character transmitting and receiving method using the same, in a mobile communication system that provides voice communication services using a mobile terminal, such as code division multiple access (CDMA), and a system that provides voice communication services through a packet communication network, such as voice over internet protocol (VoIP).

### BACKGROUND ART

In a mobile communication system that provides voice communication services using a mobile terminal, such as CDMA, and a system that provides voice communication services through a packet communication network, such as VoIP, for hard of-hearing and speech-disabled people who suffer from difficulties in voice communications, a character input device is additionally provided on an analog signal path that provides voices in order to interface with a terminal that provides voice communications, thereby implementing character communications.

At this time, it is inconvenient in that in order to provide character communications, the character input device having modem functions always needs to interface the terminal that provides voice communications, and when using a mobile terminal that is rapidly spread in present days, the character input device should be carried together with the mobile terminal.

### DISCLOSURE OF INVENTION

### Technical Problem

Accordingly, the present invention has been made in order to solve the above problems, and it is an object of the invention to provide a character communication terminal for hard of-hearing and speech-disabled people and a character transmitting and receiving method using the same, in which a character communication function is added to a terminal itself that converts voices into digital data and performs voice communications, thereby performing character communications even without an external device.

### Technical Solution

In order to accomplish the above object of the invention, according to one aspect of the invention, there is provided a character communication terminal for hard of-hearing and speech-disabled people, the character communication terminal comprising: a user interface unit for allowing a user to input and display control commands for performing character communications or characters that the user desires to send; a physical layer unit for transferring character information; a character communication vocoder unit including a character encoding unit for encoding the characters received from the user interface unit into a format required by a character communication standard for the hard of-hearing and speech-disabled people, and a character decoding unit for extracting characters from the format encoded according to the character communication standard received from the physical layer unit and decoding the extracted characters; and a character communication control unit for controlling the character communication vocoder unit to perform character communications.

Preferably, the terminal further comprises: a voice interface unit for digitalizing a user's analog voices to perform voice communications; and a voice vocoder unit for encoding the voice information digitalized by the voice interface unit or decoding the encoded information.

According to another aspect of the invention, there is provided a method of transmitting characters using a character communication terminal for hard of-hearing and speech-disabled people, the method comprising the steps of: setting a character communication; inputting characters by the user interface unit; encoding the inputted characters to conform to the character communication standard for hard of-hearing and speech-disabled people; and transmitting the encoded characters through the physical layer unit.

According to another aspect of the invention, there is provided a method of receiving characters using a character communication terminal for hard of-hearing and speech-disabled people, the method comprising the steps of: receiving information from the physical layer unit; separating voice information and character information that is encoded to conform to a character communication standard for the hard of-hearing and speech-disabled people from the received information; decoding the character information; and transmitting the decoded characters to the user interface unit.

### ADVANTAGEOUS EFFECTS

As described above, the character communication terminal for hard of-hearing and speech-disabled people and a character transmitting and receiving method using the same are effective in that a character communication function is added to the terminal without any modification in communication systems, and thus hard of-hearing and speech-disabled people can perform character communications with a mobile terminal or a VoIP terminal of a counterpart using only the terminal of the present invention.

### BRIEF DESCRIPTION OF THE DRAWINGS

Further objects and advantages of the invention can be more fully understood from the following detailed description taken in conjunction with the accompanying drawings in which:

FIG. 1 is a view showing the configuration of a terminal according to a preferred embodiment of the present invention;

FIG. 2 is a flowchart illustrating the transmission procedure of the character communication control unit according to a preferred embodiment of the present invention;

FIG. 3 is a flowchart illustrating the reception procedure of the character communication control unit according to a preferred embodiment of the present invention; and

FIG. 4 is a conceptual view showing bit mapping diagrams according to a preferred embodiment of the present invention.

### BEST MODE FOR CARRYING OUT THE INVENTION

Hereinafter, the preferred embodiment of the present invention will be described in detail with reference to the accompanying drawings. FIG. 1 is a view showing the configuration of a terminal for performing character communications for hard of-hearing and speech-disabled people according to the present invention. The terminal for performing character communications of the present invention comprises a user interface unit 20 for inputting control commands for performing character communications, inputting characters that a user desires to send, and performing a display function, a character communication vocoder unit 40 for encoding or decoding the characters inputted from the user interface unit 20 so as to conform to a character communication standard for hard of-hearing and speech-disabled people, and a character communication control unit 50 for setting whether or not to perform character communications through the character communication vocoder unit 40 in response to a command of the user interface unit 20 and executing control functions to perform character communications according to the setting.

The character communication terminal further comprises a voice interface unit 10 for digitalizing user's analog voices to perform voice communications, a voice vocoder unit 30 including an encoding unit 32 for encoding voices received from the voice interface unit 10 and a decoding unit 34 for decoding voices to be transmitted to the voice interface unit 10, and a physical layer unit 60 for transferring voice frames including voice information or character information.

The terminal according to the present invention comprises the voice interface unit 10 and the voice vocoder unit 30 as described above, and thus not only hard of-hearing and speech-disabled people in need of character communications, but also general users who desire to perform voice communications can use the terminal.

The character communication vocoder unit 40 comprises a character encoding unit 42 for creating virtual voice frames by encoding characters received from the user interface unit 20 into the format conforming to the character communication standard for hard of-hearing and speech-disabled people, and a character decoding unit 44 for extracting encoded characters from the voice frames received through the character communication control unit 50 and decoding the extracted characters.

The character communication standard for hard of-hearing and speech-disabled people is a method of mapping character information to a voice frame specified by 3GPP2 or 3GPP. 3GPP2 is the standard organization of synchronous CDMA, and 3GPP is the standard organization of asynchronous CDMA.

The character communication control unit 50 is informed of character communication setting inputted from the user interface unit 20 and sets whether or not to perform character communications, and if character information is inputted from the information received from the physical layer unit 60, the character communication control unit 50 controls the character communication vocoder unit 40 to perform its functions.

The solid lines in FIG. 1 show transmitting and receiving of voice information and character information, and the dashed line connecting the user interface unit 20 to the character communication control unit 50 is the path of control commands issued by the user interface unit 20 for setting or releasing character communications.

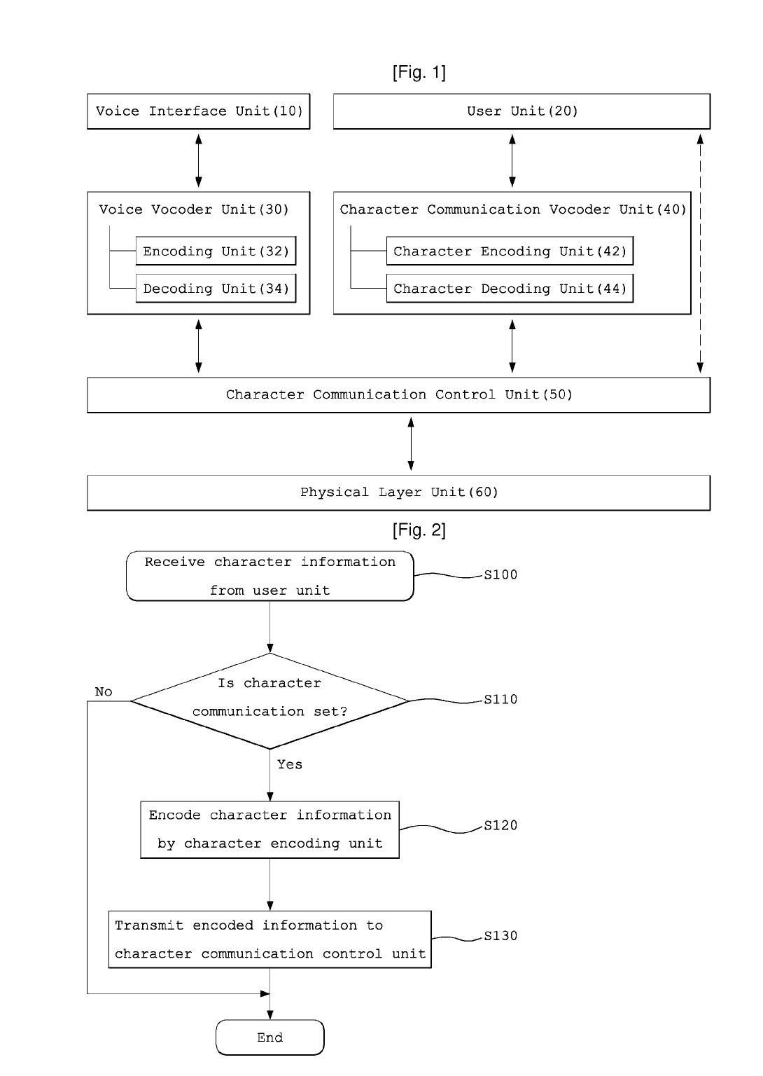

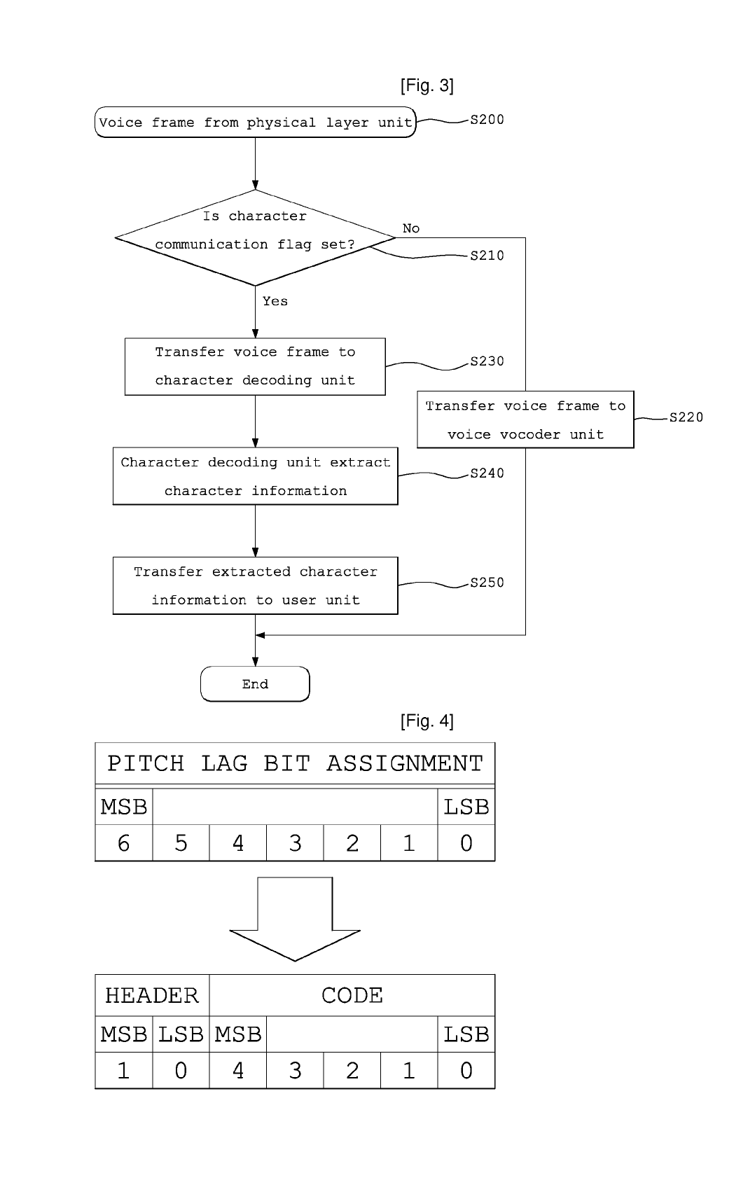

FIGS. 2 and 3 are flowcharts illustrating the transmitting and receiving procedures for performing character communications of the character communication control unit 50.

First, the transmitting procedure of the character communication control unit 50 will be described hereinafter.

If character information is inputted from the user interface unit 20 (S110), it is determined whether or not a character communication is set (S110). If the character communication is not set, the inputted characters are transferred to and formatted in a functional unit and than sent to the physical layer unit 60 as a character message does, whereas if the character communication is set, the character encoding unit 42 encodes the character information (S120) and transmits the encoded information to the character communication control unit 50 (S130).

The character communication control unit 50 that has received the encoded character information transmits the character information to the communication counterpart through the physical layer unit 60.

Next, the receiving procedure of the character communication control unit 50 will be described hereinafter.

A voice frame containing character information or voice information is received by the physical layer unit 60 (S200), and it is determined whether a character communication flag is set within the voice frame (S210). Here, the information where the character communication flag is set is character information encoded to conform to the character communication standard.

If the character communication flag is not set, the voice frame is transferred to the voice vocoder unit 30 (S220), whereas if the character communication flag is set within the voice frame, the voice frame is transferred to the character decoding unit 44 of the character vocoder unit 40 (S230) and divided into voice information and character information. Next, the voice frame transferred to the character decoding unit 44 is decoded and character information is extracted (S240). The character decoding unit 44 transfers the extracted character information to the user interface unit 20 (S250), and the program is terminated. The character information transferred to the user interface unit 20 is outputted through the display unit, and the user can perform character communications with the counterpart.

FIG. 4 is a conceptual view showing bit mapping of 5-bits Baudot code applied to the 8 kbps enhanced variable rate CODEC (EVRC) vocoder in CDMA 1x. An example of transferring voices using 8 kbps EVRC codec applied to CDMA 1x systems will be described. The MSB shown in the figure is the abbreviation of most significant bit, and the LSB is the abbreviation of least significant bit.

First, applying the 8 kbps EVRC vocoder that is applied to CDMA 1x, the last bit of a voice frame transmitted and received every 20 milliseconds is used as a flag bit for confirming whether it is a general voice communication or a character communication, in which the flag bit is set to “1” in the case of a character communication. In addition, in FIG. 4, character communication information is assigned to the PITCH LAG bits of the 20 millisecond voice frame, and the other bits are not used.

Accordingly, if the character encoding unit 42 of the character communication vocoder unit 40 assigns character information conforming to the format to the bits corresponding to the PITCH LAG, and transmits the information, the information can be processed in the same manner as the output value of the encoding unit 32 of the voice vocoder unit 30.

Although the present invention has been described with reference to a preferred embodiment, the description is merely illustrative of the character communication terminal for hard of-hearing and speech-disabled people and a character transmitting and receiving method using the same according to the present invention and is not to be construed as limiting the invention. Various modifications and variations may occur to those skilled in the art, without departing from the scope of the invention as defined by the appended claims.

### INDUSTRIAL APPLICABILITY

As described above, in the character communication terminal for hard of-hearing and speech-disabled people and a character transmitting and receiving method using the same according to the present invention, a character communication function is added to the terminal without any modification in communication systems, and thus hard of-hearing and speech-disabled people can freely perform character communications.

1. A character communication terminal for hard of-hearing and speech-disabled people, the character communication terminal comprising:
a user interface unit for allowing a user to input and display control commands for performing character communications or characters that the user desires to send;
a physical layer unit for transferring character information;
a character communication vocoder unit including a character encoding unit for encoding the characters received from the user interface unit into a format required by a character communication standard for the hard of-hearing and speech-disabled people, and a character decoding unit for extracting characters from the format encoded according to the character communication standard received from the physical layer unit and decoding the extracted characters; and
a character communication control unit for controlling the character communication vocoder unit to perform character communications.

2. The terminal according to claim 1, further comprising:
a voice interface unit for digitalizing user's analog voices to perform voice communications; and
a voice vocoder unit for encoding the voice information digitalized by the voice interface unit or decoding the encoded information.

3. A method of transmitting characters using a character communication terminal for hard of-hearing and speech-disabled people, the method comprising the steps of:
setting a character communication;
inputting character information by a user interface unit;
encoding the inputted character information to conform to a character communication standard for the hard of-hearing and speech-disabled people; and
transmitting the encoded character information through a physical layer unit

4. A method of receiving characters using a character communication terminal for hard of-hearing and speech-disabled people, the method comprising:
receiving information from a physical layer unit;
separating voice information and character information that is encoded to conform to a character communication standard for the hard of-hearing and speech-disabled people from the received information;
decoding the character information; and
transmitting the decoded characters to a user interface unit.
